(19) United States
(12) Patent Application Publication
(10) Pub. No.: US 2018/0062823 A1
(43) Pub. Date: Mar. 1, 2018

(54) BASE STATION AND METHOD USING A BASE STATION

(71) Applicant: FUJITSU LIMITED, Kawasaki-shi (JP)

(72) Inventor: Tsuyoshi HASEGAWA, Kawasaki (JP)

(73) Assignee: FUJITSU LIMITED, Kawasaki-shi (JP)

(21) Appl. No.: 15/669,646

(22) Filed: Aug. 4, 2017

(30) Foreign Application Priority Data
Aug. 30, 2016 (JP) 2016-167857

(51) Int. Cl. H04L 5/14; H04B 7/26; H04W 72/04; H04W 72/08

(52) U.S. Cl. CPC H04L 5/1461; H04B 7/2621; H04W 88/08; H04W 72/082; H04W 72/0453

(57) ABSTRACT

A base station includes a transmitter configured to transmit a downlink signal to a terminal device in a first frequency band, a receiver configured to receive an uplink signal from the terminal device in a second frequency band narrower than the first frequency band, at least a part of the second frequency band being included in the first frequency band, and a canceller circuit configured to execute a suppression process of a self-interference in which the downlink signal transmitted from the transmitter reaches the receiver and interferers with the uplink signal, wherein the canceller circuit executes the suppression process by limiting to a third frequency band including the second frequency band and not including at least a part of the first frequency band.

### CROSS-REFERENCE TO RELATED APPLICATION(S)

This application is based upon and claims the benefit of priority of the prior Japanese Patent Application No. 2016-167857, filed on Aug. 30, 2016, the entire contents of which are incorporated herein by reference.

### FIELD

The embodiment discussed herein is related to a base station and a method using a base station.

### BACKGROUND

A two-way communication technology called in-band full duplex is attracting attention. In the in-band FD, communication capacity can be expanded more than that of a frequency division duplex (FDD) or a time division duplex (TDD) by simultaneously performing transmission and reception using the same frequency. Japanese Laid-open Patent Publication No. 5-304492, Japanese National Publication of International Patent Application No. 2003-509944, Japanese Laid-open Patent Publication No. 2003-179520, and Japanese Laid-open Patent Publication No. 7-74531 are examples of related art.

### SUMMARY

According to an aspect of the invention, a base station includes a transmitter configured to transmit a downlink signal to a terminal device in a first frequency band, a receiver configured to receive an uplink signal from the terminal device in a second frequency band narrower than the first frequency band, at least a part of the second frequency band being included in the first frequency band, and a canceller circuit configured to execute a suppression process of a self-interference in which the downlink signal transmitted from the transmitter reaches the receiver and interferers with the uplink signal, wherein the canceller circuit executes the suppression process by limiting to a third frequency band including the second frequency band and not including at least a part of the first frequency band.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of a wireless communication system according to a first embodiment;

FIG. 2A is a diagram illustrating a signal format example in a frequency division duplex (FDD), FIG. 2B is a diagram illustrating a signal format example in a time division duplex (TDD), and FIG. 2C is a diagram illustrating a signal format example in an in-band full duplex;

FIG. 3 is a block diagram illustrating an example of a self-interference canceler (SIC) technology;

FIG. 4 is a block diagram illustrating a configuration example of a transmitting and receiving apparatus using an analog SIC and a digital SIC according to the first embodiment;

FIGS. 5A and 5B are diagrams illustrating the signal format examples according to the first embodiment;

FIG. 6 is a block diagram illustrating a configuration example of the transmitting and receiving apparatus according to the first embodiment;

FIG. 7 is a diagram illustrating an example of a relationship between the number of subcarriers and a peak to average power ratio (PAPR) to be used in orthogonal frequency-division multiplexing (OFDM);

FIG. 8 is a block diagram illustrating a configuration example of the transmitting and receiving apparatus according to a first modification example of the first embodiment;

FIG. 9 is a diagram illustrating an example of passband characteristics of a passband filter (BPF) illustrated in FIG. 8;

FIG. 10 is a diagram illustrating an example of the other passband characteristics of the passband filter (BPF) illustrated in FIG. 8;

FIG. 11 is a diagram illustrating a signal format example according to a second modification example of the first embodiment;

FIG. 12 is a diagram illustrating a signal format example according to a third modification example of the first embodiment;

FIG. 13 is a diagram illustrating a signal format example according to a fourth modification example of the first embodiment;

FIG. 14 is a diagram illustrating a signal format example according to a fifth modification example of the first embodiment;

FIG. 15A is a diagram illustrating a signal format example of a self-contained TDD frame and FIG. 15B is a diagram illustrating a signal format of a flexible TDD frame;

FIG. 16 is a diagram illustrating a signal format example in which the self-contained TDD frame and the flexible TDD frame are combined;

FIG. 17 is a diagram illustrating a signal format example in which the self-contained TDD frame and the flexible TDD frame are combined according to a sixth modification example of the first embodiment;

FIG. 18 is a block diagram illustrating a configuration example of a base station according to the first embodiment; and

FIG. 19 is a sequence diagram illustrating an operation example focusing on scheduling of the wireless communication system according to the first embodiment.

### DESCRIPTION OF EMBODIMENT

Since a transmission signal with much higher power than reception signal power leaks into a receiving system and causes self interference in an in-band FD, an appropriate receiving process is difficult to be performed unless some countermeasure is taken.

Therefore, a self-interference canceler (SIC) technology is widely reviewed to realize the in-band FD. In SIC, a process in an analog domain and a process of a digital domain are included. In the process in the digital domain, processing load tends to increase as a frequency band to be processed becomes wider.

Hereinafter, embodiments will be described with reference to drawings. However, the following embodiments are just examples, and hence various variations or technical applications thereof which are not clearly mentioned in the following embodiments are not excluded. In addition, various exemplary embodiments described below may be appropriately combined. In the drawings used in the following embodiments, the same reference numerals denote the same or similar parts unless otherwise specified.

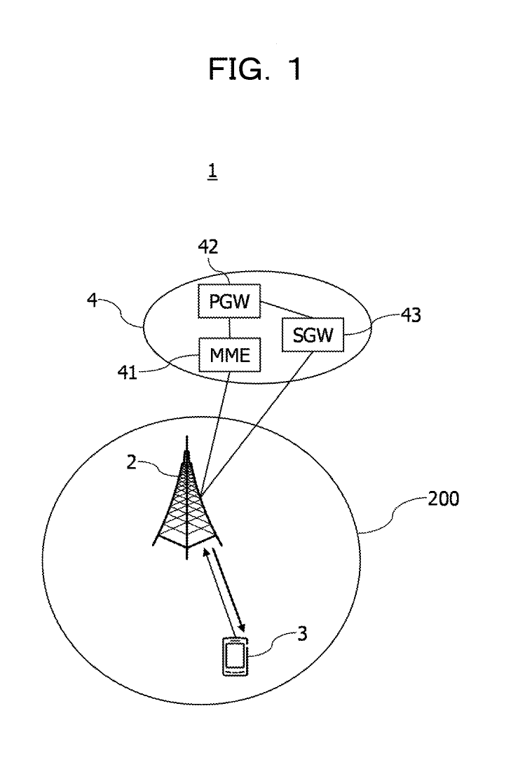

FIG. 1 is a block diagram illustrating a configuration example of a wireless communication system according to a first embodiment. Illustratively, a wireless communication system 1 illustrated in FIG. 1 may include a base station 2 and a wireless terminal 3. Illustratively, the base station 2 may be coupled to a core network 4. In an example of FIG. 1, one base station 2 and one wireless terminal 3 are focused on. However, both of the base station 2 and the wireless terminal 3 may exist in two or more in the wireless communication system 1.

The wireless terminal (hereinafter, it may be abbreviated as the “terminal”) 3 is capable of wireless communication with the base station 2 in a wireless area formed or provided by the base station 2. The “wireless terminal” may be referred to as a “wireless device”, a “wireless apparatus”, a “terminal device”, or the like.

The terminal 3 may be a fixed terminal whose position does not change or may be a mobile terminal whose position changes (may be referred to as a “mobile device”). As a non-limiting example, the terminal 3 may be a mobile UE such as a mobile phone, a smartphone, or a tablet terminal. “UE” is an abbreviation for “user equipment”.

In addition, the terminal 3 may be an Internet of things (IoT) terminal. By the IoT, communication functions can be equipped with various “objects”. The various “objects” equipped with the communication functions can perform communication by coupling to the Internet, a radio access network, or the like.

For example, a sensor device, a meter (measuring device), or the like provided with the wireless communication functions may be included in the IoT terminal. Any monitoring device such as a monitoring camera or a fire alarm equipped with the sensor device or the meter may correspond to the terminal 3.

For convenience, the wireless communication between the base station 2 and the terminal 3 may be referred to as a “cellular communication”. In the “cellular communication”, for example, a wireless communication system based on LTE may be applied.

The wireless communication between the terminal 3 that is the IoT terminal of the monitoring device or the like and the base station 2 is referred to as machine type communications (MTC) in some cases, and the terminal 3 is referred to as a “MTC device” in some cases. The IoT terminal or the MTC device may also be regarded as an example of UEs.

The base station 2 forms or provides a wireless area 200 enabling wireless communication with the wireless terminal 3. The “wireless area” may be referred to as a “cell”, a “coverage area”, a “communication area”, a “service area”, and the like.

The base station 2 may be, for example, “eNB” based on long term evolution (LTE) or 3rd Generation Partnership Project (3GPP) or LTE-Advanced (hereinafter, collectively referred to as “LTE”).

“eNB” is an abbreviation for “evolved Node B”. A communication point which is referred to as remote radio equipment (RRE), a remote radio head (RRH), or the like and disposed separately from the base station body, may correspond to the base station 2.

The “cell” formed or provided by the base station 2 may be divided into “sector cells”. A macro cell or a small cell may be included in the “cell”. The small cell is an example of a cell with the smaller wave coverage (coverage) than the macro cell.

The small cell may be named differently depending on the coverage area. For example, the small cell may be referred to as “femtocell”, “picocell”, “microcell”, “nanocell”, “metrocell”, “homecell”, and the like.

The term “cell” means not only the individual geographical range that the base station 2 provides wireless service but also a part of the communication function managed by the base station 2 for communicating with the terminal 3 in the individual geographical range.

As illustrated in FIG. 1, a MME 41, a PGW 42, and a SGW 43 may be included in the core network 4. “MME” is an abbreviation for a “mobility management entity”. “PGW” is an abbreviation for a “packet data network gateway”, AND “SGW” is an abbreviation for a “serving gateway”.

The core network 4 may be referred to as a “backbone network 4” or may be referred to as a “high-order network 4” for the base station 2. The MME 41, the PGW 42, and the SGW 43 may be regarded as a network element (NE) or an entity of the “core network” and may be collectively referred to as a “core node”. The “core node” may be regarded as a “high-order node” of the base station 2.

The base station 2 may be coupled to the core network 4 by an “S1 interface” which is an example of a wired interface. However, the base station 2 may be communicatively coupled to the core network 4 via a wireless interface.

The network including the base station 2 and the core network 4 may be referred to as a radio access network (RAN). An example of RAN is “Evolved Universal Terrestrial Radio Access Network (E-UTRAN)”.

In addition, for example, the base station 2 may be communicatively coupled to the MME 41 and the SGW 43. The base station 2 and the MME 41 and the SGW 43 may be communicably coupled by an interface called the S1 interface, for example.

The SGW 43 may be communicatively coupled to the PGW 42 through an interface called an S5 interface. The PGW 42 may be communicably coupled to a packet data network (PDN) such as the Internet or an intranet.

The user packet can be transmitted and received between a UE3 and the PDN via the PGW 42 and the SGW 43. The user packet is an example of user data and may be referred to as a user plane signal.

Illustratively, the SGW 43 may process the user plane signal. The control plane signal may be processed by the MME 41. The SGW 43 may be communicably coupled to the MME 41 via an interface called an S11 interface.

Illustratively, the MME 41 manages positional information of the UE 3. The SGW 43 may, for example, perform movement control such as path switching of the user plane signal accompanying the movement of the UE3 based on the positional information managed by the MME 41. In the movement control, the control associated with a handover (HO) of the UE3 may be included.

Although not illustrated in FIG. 1, in a case where there are a plurality of base stations 2 in the RAN, the base stations 2 may be communicably coupled by an inter-base station interface referred to as, for example, an X2 interface. The inter-base station interface may be a wired interface or a wireless interface.

The wireless area 200 formed by the eNB2 which is an example of the base station 2 may be referred to as “macrocell”. For the sake of convenience, the eNB2 forming macrocell 200 may be referred to as “macro base station”, “macro eNB”, “MeNB”, or the like. The small cell with smaller coverage than the macrocell may be overlaid on the macrocell.

The eNB2 may control the setting (may be referred to as “allocation”) of wireless resources used for wireless communication with the UE 3. The allocation control of wireless resources (hereinafter may be abbreviated as “resources”) may be referred to as “scheduling”.

Illustratively, the resource may be distinguished in two dimensions of a frequency region and a time region, or may be distinguished in three dimensions by adding a power region or a code region in frequency region and time region.

The eNB2 may perform resource allocation on the resource available for wireless communication with the UE3, for example, in units of frequency and time grid, which are separated by the frequency region and the time region. In the LTE, the unit of scheduling is referred to as a “resource block (RB)”.

The RB corresponds to one block obtained by dividing a wireless resource usable for wireless communication with the UE3 by the eNB2 in units of slots in the time region and a plurality of adjacent subcarriers (carrier waves) in the frequency region.

For example, in the LTE, 1 slot has a time length of 0.5 ms, 2 slots constitute 1 sub-frame of 1 ms length, and a radio frame of 10 ms length is composed of 10 sub-frames.

The RB is represented by, for example, 2 slots (=1 sub-frame)×12 subcarriers. In the LTE, 1 slot×12 subcarriers are referred to as a “physical resource block (PRB)” and two PRBs within 1 sub-frame are referred to as a “PRB pair” in some cases.

Either the time division duplex (TDD) or the frequency division duplex (FDD) may be applied to the wireless communication between the eNB2 and the UE3.

A two-way communication technique called in-band full-duplex may be applied to wireless communication between the eNB2 and the UE3. The in-band full duplex may be abbreviated simply as full duplex (FD) in a case where the absence of confusion in the context of next generation (for example, fifth generation (5G)) wireless communication technology.

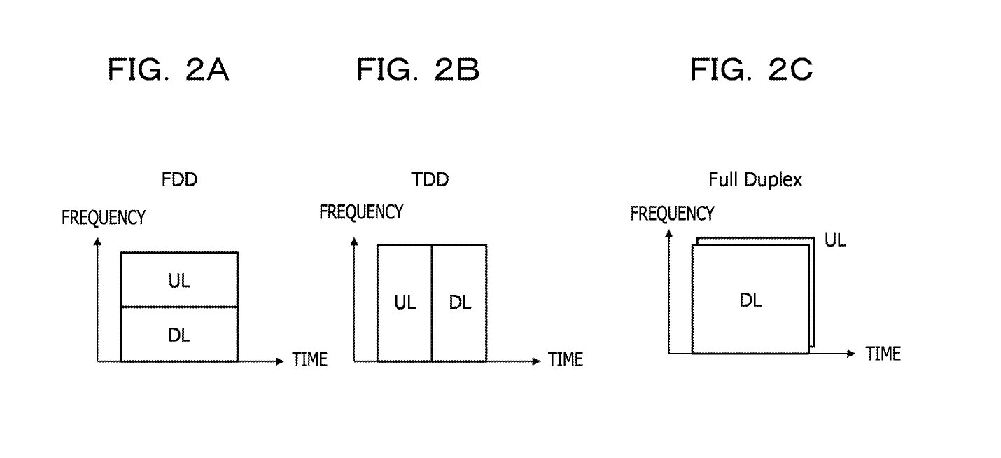

As illustrated in FIG. 2A, in the FDD, downlink (DL) communication and uplink (UL) communication are performed using the different frequencies (or frequency bands).

On the other hand, in the TDD, as illustrated in FIG. 2B, DL communication and UL communication are performed at the different times using one frequency (or frequency band).

With respect to this, in the FD, DL communication and UL communication are simultaneously performed using the same frequencies (or frequency bands) as illustrated in FIG. 2C. Therefore, the FD can realize twice the communication capacity compared to the FDD and the TDD.

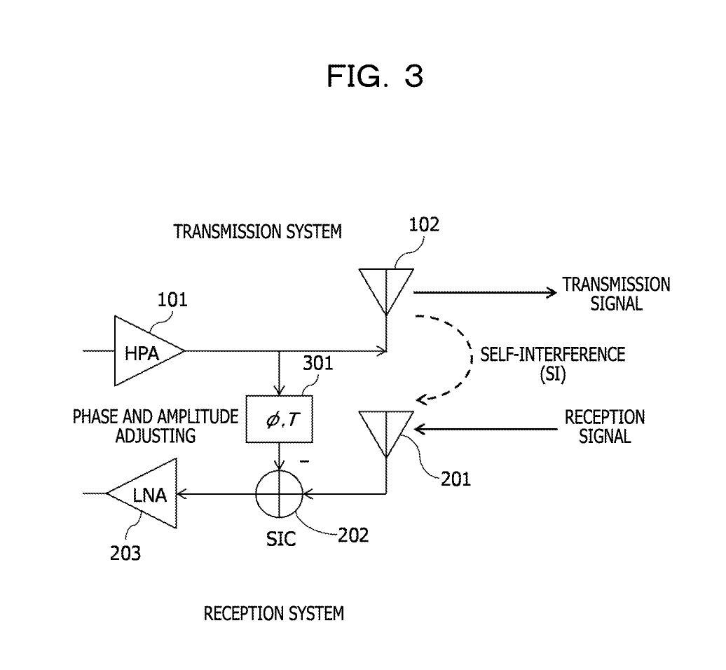

However, in the FD, as schematically illustrated in FIG. 3, there is a possibility that a transmission signal with much higher power than the power of the reception signal enters the reception system as self interference, and unless some measure is taken, a low noise amplifier (LNA) 203 provided in the reception system may be saturated. If the LNA 203 is saturated, appropriate receiving process may become impossible. In FIG. 3, reference numeral 101 denotes a high power amplifier (HPA) for amplifying a transmission signal, and reference numeral 102 denotes a transmission antenna. In addition, reference numeral 201 denotes a receiving antenna.

Therefore, it is important to apply self-interference canceler (SIC) technology to adopt the FD. FIG. 3 illustrates an example in which an SIC 202 is provided between the receiving antenna 201 and the LNA 203.

Reference numeral 301 denotes a phase and amplitude adjuster.

The SIC 202 cancels the self-interference by subtracting the transmission signal whose phase and amplitude are adjusted by a phase and amplitude adjuster 301 from the reception signal, for example. The SIC 202 illustrated in FIG. 3 is an example of an analog SIC that cancels self-interference in the process of the analog domain.

Since it is possible to suppress the self-interference with the reception signal of the transmission signal in the analog SIC 202, saturation of the LNA 203 can be suppressed.

However, in the analog SIC 202, self-interference tends to remain due to residual timing and phase difference between the transmission signal and the reception signal, or due to the residual timing or the phase difference. For example, by using digital SIC that cancels self-interference in the process of the digital domain, it is attempted to cancel the remaining self-interference components.

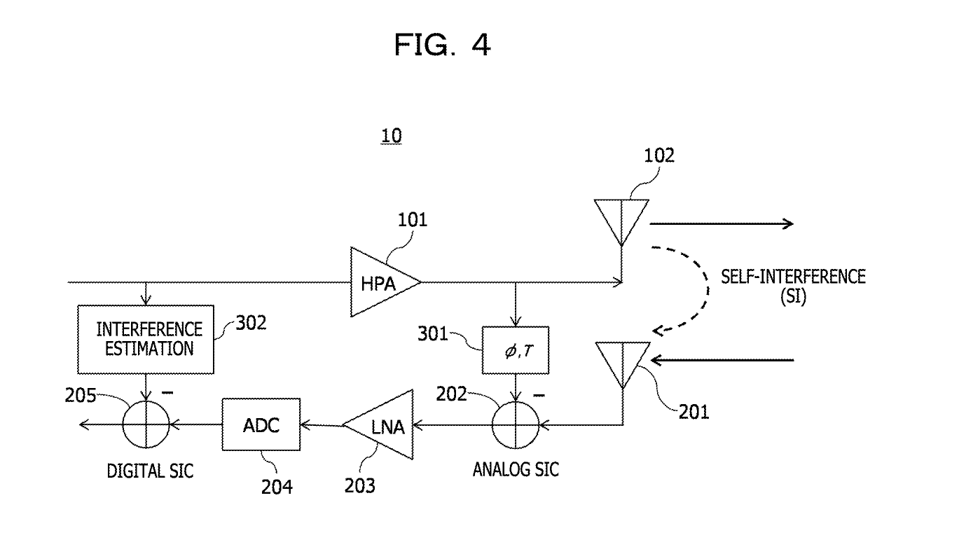

FIG. 4 illustrates a configuration example of a transceiver 10 using both the analog SIC and the digital SIC according to a first embodiment. Illustratively, the transceiver 10 may be included in the base station 2. In FIG. 4, reference numeral 202 denotes the analog SIC, and reference numeral 205 denotes the digital SIC. Reference numeral 204 denotes an analog-to-digital converter (ADC), and reference numeral 302 denotes an interference estimation unit.

The reception signal including the self-interference components remaining without being canceled by the analog SIC 202 is amplified by the LNA 203, converted into a digital signal by an ADC 204, and input to a digital SIC 205.

The digital SIC 205 cancels the self-interference components remaining in the reception digital signal by subtracting the self-interference components estimated based on the transmission signal by the interference estimating unit 302 from the reception digital signal input from the ADC 204.

As described above, according to the configuration illustrated in FIG. 4, the main self-interference is suppressed in the analog domain to suppress the saturation of the LNA 203, and suppression of self-interference components remaining in the digital domain that is not suppressed in the analog domain.

However, when using the digital SIC 205, an amount of operation for interference estimation (which may be referred to as “processing load”) increases as compared with the case of using the analog SIC 202 as a single unit, and the calculation amount also tends to increase as the signal bandwidth to be processed becomes wider.

In the present embodiment, for example, by limiting the signal bandwidth of the SIC processing, the amount of the operation can be reduced. For example, in the wireless communication system 1, an UL traffic volume tends to be smaller than the DL traffic volume. Therefore, the frequency bandwidth assignable to the UL may be limited and aggregated to a partial band narrower than the frequency band that can be allocated to the DL.

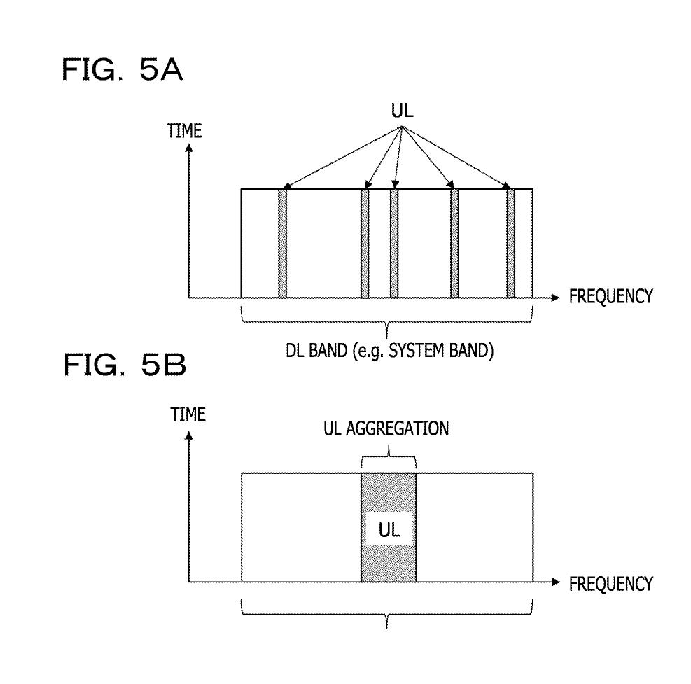

FIG. 5A and FIG. 5B schematically illustrate a frequency resource allocation example (in other words, a signal format example) according to the first embodiment. The “frequency resource” means a frequency or a frequency band. FIG. 5A illustrates an example in which different frequency resources are distributedly allocated to each of a plurality of UL signals in a frequency resource (for example, a system bandwidth) that can be allocated to a DL signal.

For example, when the eNB2 selects and allocates frequency resources as much as possible to the frequency resources which exhibits good condition for each of the plurality of UEs 3, even if the UL traffic volume is small, as illustrated in FIG. 5A, a plurality of UL signals may be distributed over entire system frequency band in some cases.

In this case, since the band in which the UL signal is distributed (in some cases, all of the system band) becomes the object of the SIC process, it is difficult to suppress the amount of the operation related to the SIC process.

For example, as schematically illustrated in FIG. 5B, the frequency resource allocated to the UL signal of each UE3 is aggregated or limited to a part of the region of the frequency band (may be referred to as the “DL band” for convenience) that can be allocated to the DL signal.

For the sake of convenience, the part of the band may be referred to as a “UL aggregation band” or a “UL limitation band”. The DL band is an example of a first frequency band, and the UL aggregation band is an example of a second frequency band.

Illustratively, the UL aggregation band may be a frequency band in the center of the system band or in the vicinity of the center. In addition, two or more UL aggregation bands may exist in the DL band. Furthermore, all of the UL aggregation bands may be assigned to the UL signal, or a part of the UL aggregation bands may be assigned to the DL signal. In other words, all of the UL aggregation bands may not be occupied by the transmission of the UL signal.

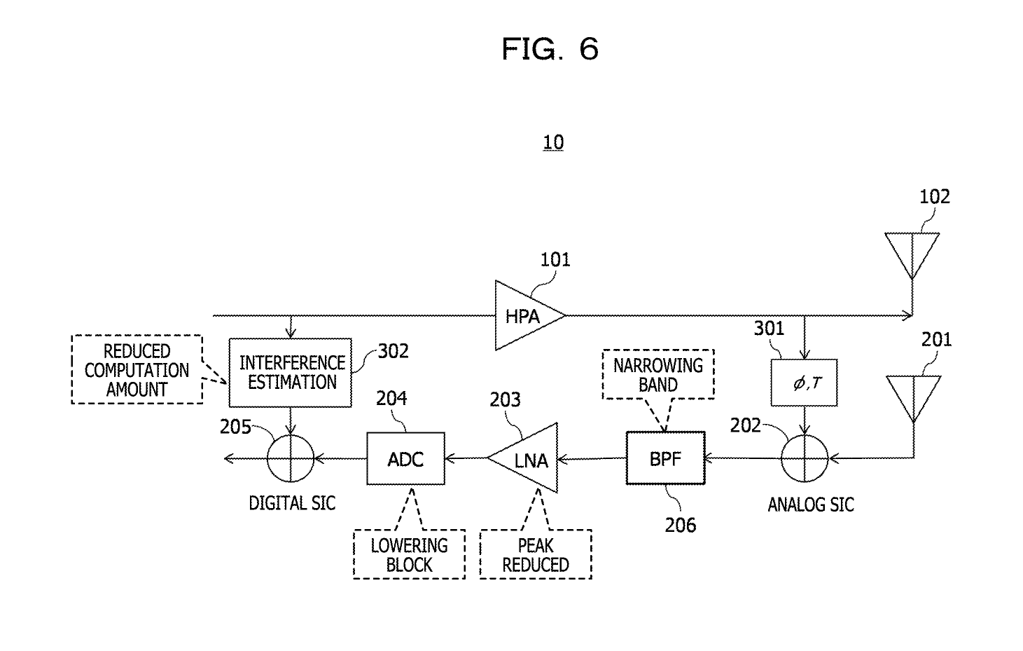

Assuming that one UL aggregation band is set in the DL band, as illustrated in FIG. 6, a band pass filter (BPF) 206 for passing a signal of the UL aggregation band may be provided between, for example, the analog SIC 202 and the LNA 203.

The BPF 206 is an example of an analog filter that cuts out the UL signal in the UL aggregation band which is an example of a second frequency band in the analog domain. Since the peak power of the input signal to the LNA 203 can be reduced by the BPF 206, saturation of the LNA 203 less likely happen.

In addition, since the signal bandwidth to be processed by the SIC is narrowed down to the UL aggregation band by the BPF 206, a dynamic range or a clock frequency requested for the ADC 204 can also be reduced, or the power consumption can be reduced. Furthermore, since the amount of operation in the interference estimating unit 302 can also be reduced, the power consumption can further be reduced.

For example, when the signal bandwidth of the UL can be narrowed down to ¼ of the system bandwidth by the BPF 206, the clock of the ADC 204 can also be reduced to ¼ and the amount of the operation of the interference estimating unit 302 can also be reduced to ¼.

In addition, in the interference estimation in the interference estimating unit 302, in a case where a two-dimensional nonlinearity of the HPA 101 is concerned, since the amount of the operation for interference estimation can also varied on the order of the square, there is a possibility that the amount of the operation can further be reduced than ¼.

As described above, in the FD, instead of using the same bandwidth in the DL band and the UL band, by aggregating or limiting the UL band to a part of the DL band, the amount of operation related to the SIC process in the FD, or the power consumption of the transceiver 10 and the power consumption of the base station 2 can be reduced.

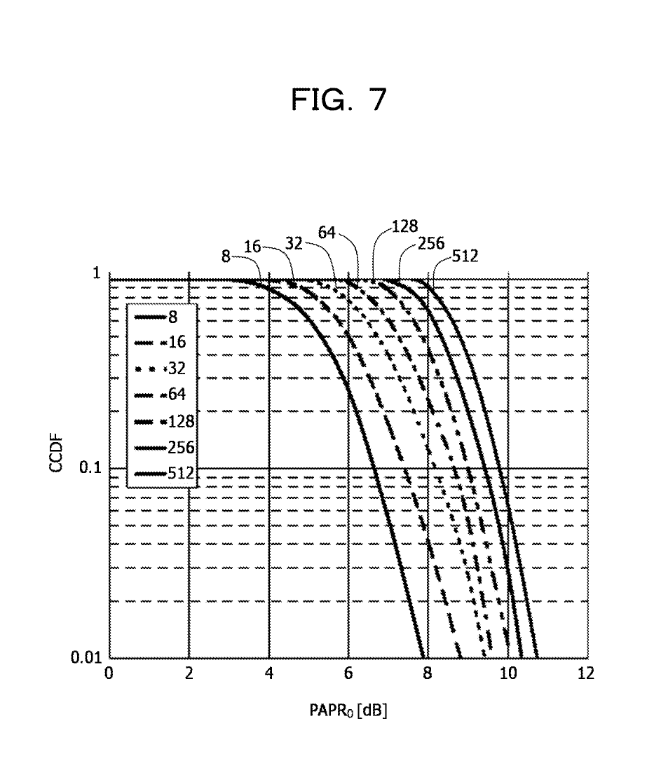

FIG. 7 illustrates an example of the relationship between the number of subcarriers and the PAPR to be used in OFDM. FIG. 7 is a reference of FIG. 5 of Non-Patent Literature 1. The OFDM is an abbreviation for “orthogonal frequency-division multiplexing” and the PAPR is an abbreviation for a “peak to average power ratio”.

As illustrated in FIG. 7, if the number of subcarriers is reduced from 512 to 64, the PAPR can be reduced by 1 dB stronger at CCDF=0.1. CCDF is a complementary cumulative distribution function whose cumulative probability exhibits a cumulative probability of amplitude exceeding a certain value. Accordingly, by narrowing the UL signal band to the UL aggregation band and reducing the number of subcarriers, backoff of the LNA 203 can be reduced and the power amplification efficiency of the LNA 203 can be improved.

### First Modification Example

If the passband of the BPF 206 illustrated in FIG. 6 is fixed, the data amount of the UL (may be referred to as a “traffic volume”) may be limited by the passband of the BPF 206.

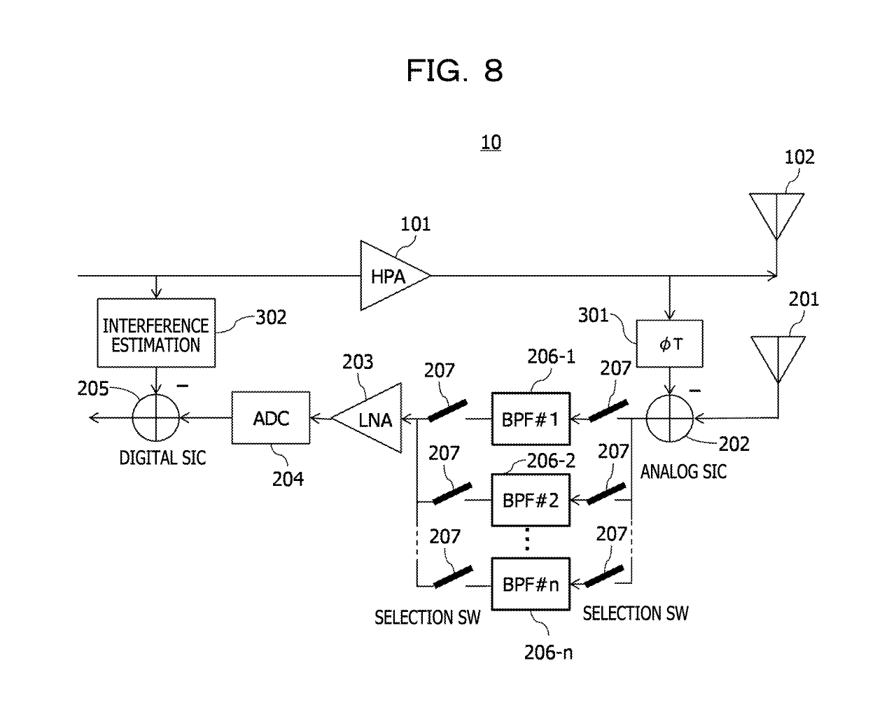

As illustrated in FIG. 8, the transceiver 10 is provided with a plurality of BPFs 206-1 to 206-n (n is an integer of 2 or more), and in accordance with the UL traffic volume, BPFs 206-i (i is any of 1 to N) can be switched by a selection switch 207.

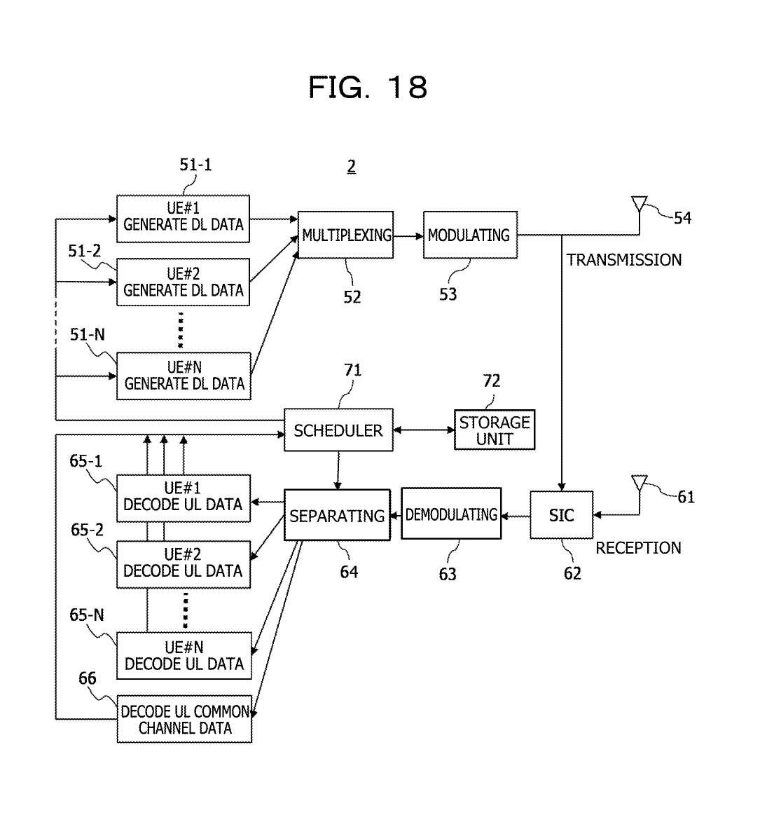

Switching of the selection switch 207 may illustratively be controlled by a scheduler 71 to be described later with reference to FIG. 18. By switching the BPF 206-i, the bandwidth of the signal passed from the analog SIC 202 to the LNA 203 can be varied according to the UL traffic volume.

The traffic volume of the UL can be estimated, for example, by aggregating a scheduling request (SR) and a buffer status report (BSR) received from the plurality of UEs 3 coupled to the eNB2.

The SR is an example of a signal requesting the eNB2 to allocate resources used by the UE 5 for data transmission of the UL and the BSR is an example of a signal for reporting the amount of transmission data held by the UE 3 to the eNB2.

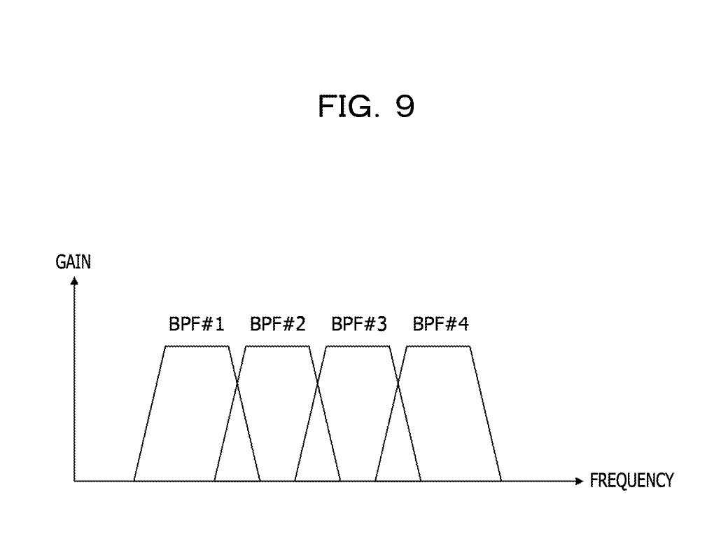

As illustrated in FIG. 9, one BPF 206-i, for example, may have bandpass characteristics corresponding to one sub-band in a case where the DL band (Illustratively, it may be a system band.) is divided into a plurality of sub-bands.

By controlling the selection switch 207, the eNB2 may select the number of BPFs 206-i corresponding to the traffic volume of the estimated UL.

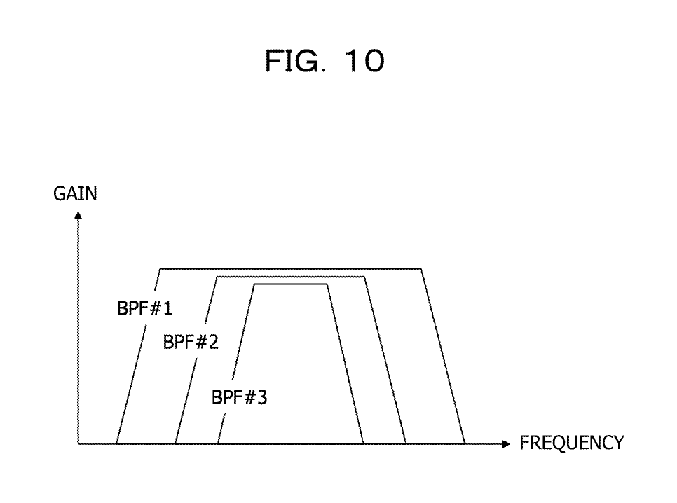

Alternatively, at least two or more BPFs 206-i may have different passband widths as illustrated in FIG. 10. The eNB2 may select the BPF 206-i of the pass bandwidth corresponding to the traffic volume of the estimated UL by controlling the selection switch 207.

In addition, a part or all of the plurality of BPFs 206-i may be realized by one variable BPF whose the passband width is variable. The eNB2 may control the pass bandwidth of the variable BPF to a bandwidth corresponding to the traffic volume of the UL. In this case, the selection switch 207 may be unnecessary.

### Second Modification Example

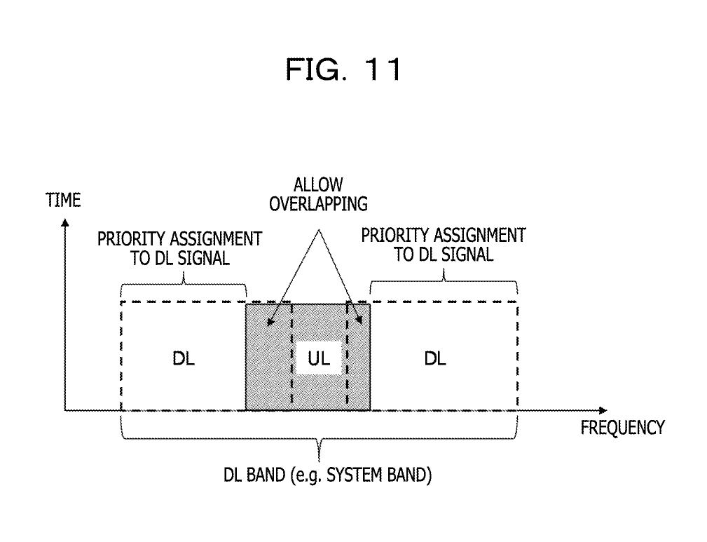

Next, a second modification will be described with reference to FIG. 11. As illustrated in FIG. 5B, it is assumed that the frequency resources allocated to the UL signal can be aggregated in a part of the bandwidth of the DL band.

In this case, in a case where the traffic volume is the traffic volume that the eNB2 intends to transmit in DL is sufficient for a part of the DL band, in the scheduling, the eNB2 may preferentially assign unallocated frequency resources to the DL signal as the UL signal.

For example, as illustrated in FIG. 11, the eNB2 may preferentially allocate the frequency resource to the DL signal as long as there is a frequency resource that does not overlap with the UL aggregation band in the system band at the time of scheduling.

Therefore, the number of DL signals to which the frequency resources overlapping the UL aggregation band is allocated can be reduced, and the self-interference is reduced and the reception performance of the UL in the eNB2 can be improved.

In a case where there is no frequency resource that does not overlap the UL aggregation band, the eNB2 may allocate the frequency resource overlapping the UL aggregation band to the DL signal. In other words, at least a partial overlap between the frequency resource allocated to the DL signal and the UL aggregation band may be permitted.

### Third Modification Example

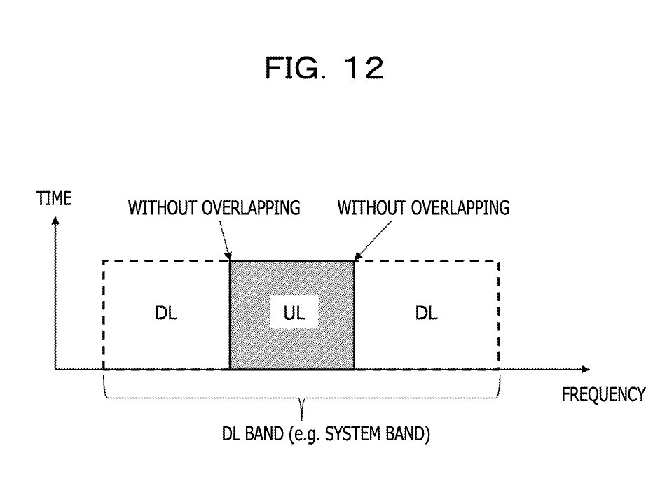

Next, a third modification will be described with reference to FIG. 12. In the second modification, the frequency resources unallocated to the UL signal are preferentially allocated to the DL signal, and in a case where there is no unallocated frequency resource in the UL signal, the frequency resource overlapped with the frequency resource allocated to the UL signal is permitted to be assigned to the DL signal.

With respect to this, in the third modification, as schematically illustrated in FIG. 12, the eNB2 may limit the frequency resource allocated to the DL signal to the frequency resources unallocated to the UL signal.

Accordingly, since it is possible to suppress the number of DL signals to which the frequency resources overlapping the UL aggregation band are allocated, the self-interference at the eNB2 is reduced and reception performance of the UL can be improved.

Strictly, the third modification example corresponds to the FDD rather than the FD. However, the third modification example has the same aspect as the FD. For example, in a common FDD, the frequency resource of the UL and the frequency resource of the DL are set to be sufficiently separated.

The reason is that since it is difficult to realize a frequency filter capable of sharply cutting off the passband, when the frequency is close to that of the transmission and the reception, similar to the FD, the transmission signal may leak into the receiving system and cause interference due to incomplete filter characteristics.

Therefore, in the sense that in a case where the frequency resource of the UL and the frequency resource of the DL are close to each other, the SIC process is effective, the eNB2 may have the same configuration as the FD. However, since the frequency resource of the UL and the frequency resource of the DL do not overlap, the performance of the SIC process may be about 1/10 to 1/100 as compared with the performance requested in a case of the FD. Therefore, implementation of the SIC process is easy.

### Fourth Modification Example

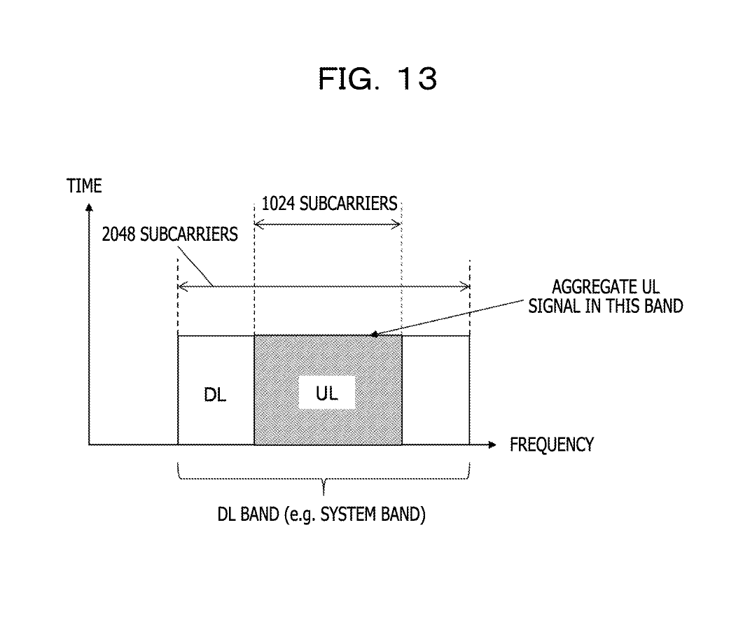

Next, a fourth modification will be described with reference to FIG. 13. In the fourth modification, it is assumed that the OFDM signal is applied to the UL and DL signals. Generally, in the FD, since the same frequency band is used for the UL and the DL, it is difficult to imagine using the OFDM signal with the different signal parameters (for example, the number of subcarriers) between the UL and the DL.

However, as described above, in the case where the frequency resource allocated to the UL signal can be aggregated and reduced in a part of the DL band (illustratively, it may be the system band), the advantageous effect can be expected by using OFDM signals with different parameters for the UL and the DL.

For example, as schematically illustrated in FIG. 13, it is assumed that the UL band is aggregated in a part of the system band which is an example of the DL band. Here, it is assumed that the number of subcarriers of the DL signal in a case where all of the system bands are used for transmission of the DL signal is “2048”.

On the other hand, the UL band is narrowed down to ½ of the system band, and when it is assumed that the same subcarrier interval as the DL is used in the UL band, the number of subcarriers in the UL band is “1024”.

The UL signal of the UL band can be generated as “0” except for the central 1024 subcarriers among the number of subcarriers=“2048”. However, the UL signal can be generated as the signal of “1024” which originally having a half number of subcarriers at the ½ bandwidth.

Since in the signal having the smaller number of the subcarriers, a fast Fourier transform (FFT) size for generating the OFDM signal is small, it can be considered that the operation efficiency is good. Therefore, in a case where the UL band is made narrower than the DL band, the operation efficiency can be improved by using a transmission signal waveform having signal parameters suitable for each of the UL band and the DL band.

### Fifth Modification Example

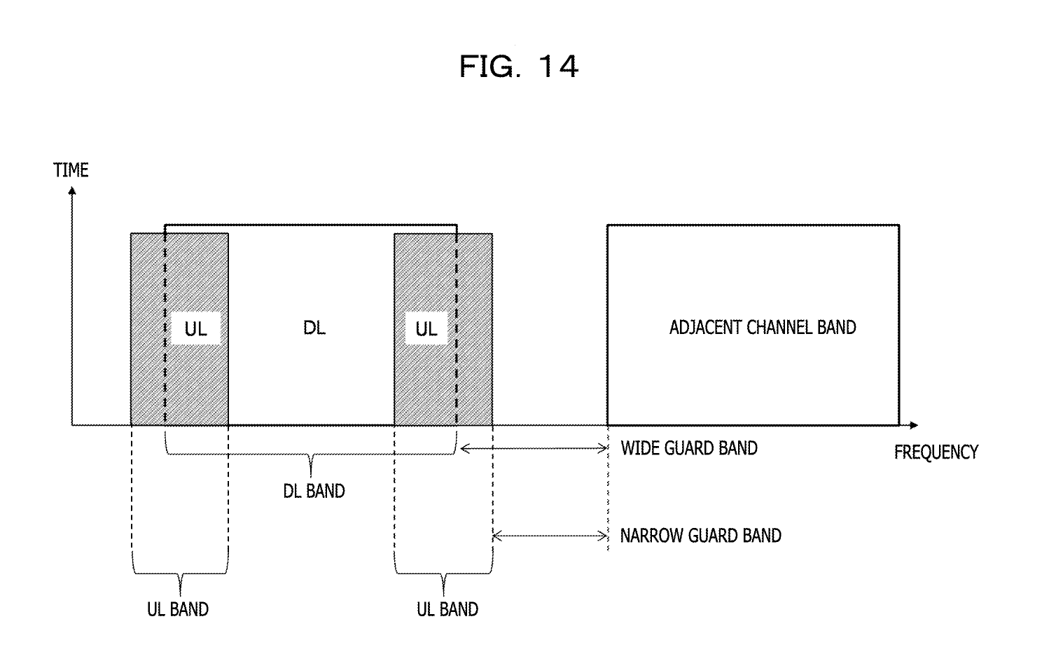

Next, a fifth modification will be described with reference to FIG. 14. In also the fifth modification, similar to the fourth modification example, it is assumed that the OFDM signal is applied to the UL and DL signals. In a case where the OFDM signal is applied, a guard band is provided between adjacent channels in order to suppress interference due to adjacent channel leakage power.

In the wireless communication system 1, since the DL transmission power of the eNB2 is overwhelmingly larger than the UL transmission power of the UE3, the guard band is determined based on the transmission power of the DL signal. For example, as schematically illustrated in FIG. 14, the guard band of the bandwidth that does not cause interference due to the adjacent channel leak power is set between the bands of the adjacent channel based on the end of the DL band.

Here, in the case of the FD, as schematically illustrated in FIG. 14, it is assumed that the UL band is aggregated on both sides outside the center of the DL band (or one side where the adjacent channels exist) with the bandwidth partially overlapping the DL band.

In other words, it is assumed that the UL aggregation band is set such that a part of the DL band deviates from the DL band on the side of the channel band disposed in the vicinity of the DL band.

Since the UL signal has a smaller transmission power than that of the DL signal, the adjacent channel leakage power is also smaller than that of the DL signal. Therefore, as schematically illustrated in FIG. 14, the guard band can be set narrower than in a case of using the DL band as a reference and the use efficiency of the frequency resource as entire the wireless communication system 1 adopting the FD can be improved.

### Sixth Modification Example

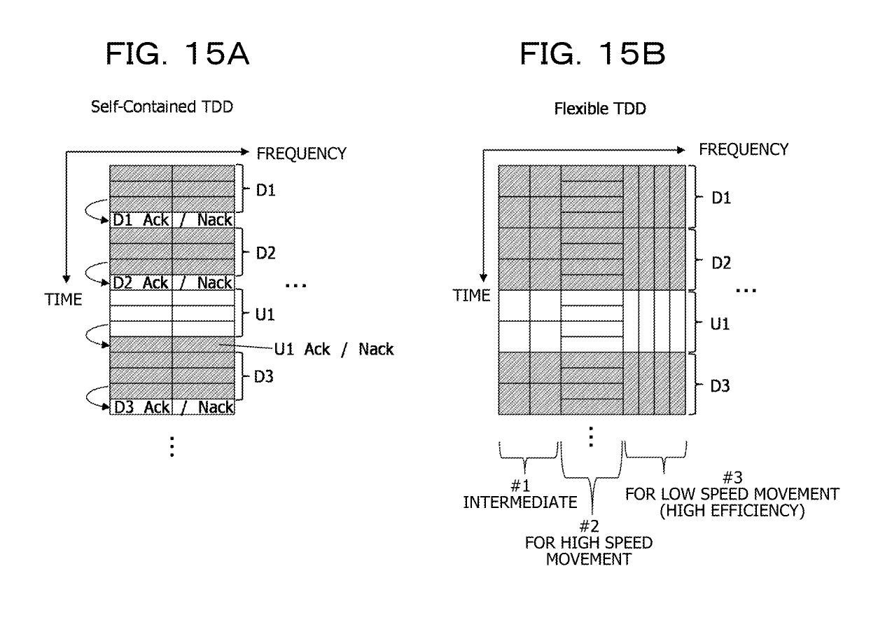

Next, a sixth modification will be described with reference to FIGS. 15A, 15B, 16, and 17. In recent years, as a new frame structure, a self-contained TDD frame configuration and a flexible TDD frame (or a dynamic TDD frame) configuration are reviewed for the realization of 5G wireless communication technology.

FIG. 15A is a diagram illustrating an example of the self-contained TDD frame and FIG. 15B is an example of the flexible TDD frame. In FIG. 15B, “#1” to “#3” may be regarded as indicating the frequency resources allocated to UE#1 to UE#3, for example. In addition, in FIGS. 15A and 15B, the hatched resource is used for the DL transmission, and the resource not hatched is used for the UL transmission. Furthermore, it may be regarded that “D1”, “D2” and “D3” indicate the DL frames of the TDD, and “U1” indicates the UL frame of the TDD.

The self-contained frame configuration indicated by #1 is an example of the TDD frame configuration for low delay communication. As illustrated in FIG. 15A, symbols indicating an Ack signal and a Nack signal which are examples of acknowledgment signals, are inserted for each sub-frame. In other words, in the self-contained frame configuration indicated by #1, the UL signal is inserted at the end of the D1, the D2 and the D3, and the DL signal is inserted at the end of the U1.

On the other hand, as illustrated in FIG. 15B, the flexible frame configuration is a configuration in which the OFDM signals having different signal parameters are separated by the filter and coexist in one frequency band (all or a part of the system band may be used).

Since the OFDM signals having the different signal parameters are separated by the filter, a wireless scheme using the flexible frame configuration is referred to as “filtered-OFDM (F-OFDM)” in some cases. In the F-OFDM, unlike the common OFDM, the orthogonality between subcarriers may not be maintained between bands (referred to as the “sub-bands”) to which filters are applied.

Accordingly, it is permitted that the signal parameters such as the number of subcarriers, subcarrier intervals, or transmission time interval (TTI) are different between the sub-bands. For example, between the sub-bands, the number of subcarriers, the number of symbols, the symbol length, the slot length, the wireless frame length, the sub-frame length (in other words, the TTI) and the like may be different. These signal parameters may remain steady within one sub-band.

Therefore, it is also permitted that OFDM symbols with different numbers of subcarriers and different symbol lengths per 1 OFDM symbol can be mixed in a certain frequency band. The OFDM symbol is an example of the “OFDM signal”.

In the example of FIG. 15B, in each of the three sub-bands #1 to #3, it can be regarded that frequency and time grids with different sizes surrounded by bold frames correspond to one OFDM symbol.

Illustratively, the OFDM symbol of the sub-band #2 has a shorter symbol length and a smaller number of subcarriers than that of the OFDM symbols of other sub-bands #1 and #3. For example, the OFDM symbol having a short symbol length may be used for the UE3 where a wireless propagation environment with the eNB2 tends to change temporally, for example, for the UE3 moving at high speed.

With respect to this, the OFDM symbol of the sub-band #3 has a longer symbol length and a larger number of subcarriers than that of the OFDM symbols of the other sub-bands #1 and #2 (in other words, having a short subcarrier interval).

The OFDM symbol of the sub-band #3 may be used for the UE3 where the wireless propagation environment does not change much with time, for example, for the UE3 moving at a low speed or the fixed UE3. In addition, since the subcarrier interval per one OFDM symbol is shorter than the other sub-bands #1 and #2, it is possible to efficiently accommodate more UEs 3 in the sub-band #3. The wireless equipment of the Internet of things (IoT) may be illustratively applied to the UE3 moving at a low speed and the fixed UE3.

The OFDM symbol of the sub-band #1 has an intermediate symbol length and the number of the subcarriers for the OFDM symbols of the sub-bands #2 and #3. The OFDM symbol of the sub-band #1 may be used, for example, for the UE3 having the average moving speed.

In this manner, the F-OFDM can separate the OFDM signals of the different signal parameters for each sub-band by the filter and coexist in a continuous frequency band. Accordingly, it is possible to use the signal parameters suitable for each communication environment for a plurality of UEs 3.

Since the symbol length can be varied by varying the number of subcarriers to be digitally modulated, it may be regarded that a matter that the number of subcarriers and the symbol length per one symbol are different means that the temporally consecutive signal waveforms as transmission units are different.

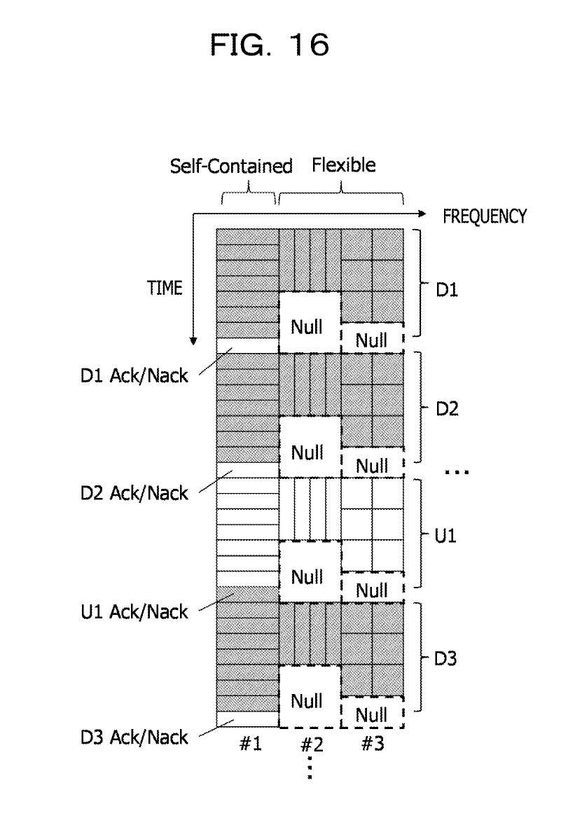

Here, when attempting to construct a self-contained and flexible frame structure by combining the frame configurations illustrated in FIGS. 15A and 15B, for example, a frame configuration as shown in FIG. 16 is obtained.

In the example of FIG. 16, the sub-band #1 has a self-contained configuration, and the symbol length is shorter than that of the other sub-bands #2 and #3 and is used for communication for the UE3 moving at a high speed.

The sub-bands #2 and #3 have the flexible configurations. Since the symbol length of sub-band #2 is longer and the subcarrier interval of sub-band #2 is shorter than that of other sub-bands #1 and #3, the sub-band #2 can accommodate the UE3 moving at low speed and the fixed UE3 with high efficiently than the other sub-bands #1 and #3.

The sub-band #3 has an intermediate symbol length and the number of subcarriers as compared with the other sub-bands #1 and #2, and is used for communication directed to the UE3 having an average moving speed, for example.

Here, when the UL reception and the DL transmission are simultaneously performed between adjacent sub-bands without using SIC processing, the interference occurs. Therefore, as illustrated by a dotted line frame in FIG. 16, the resources (Null) which is not being transmitted will inevitably occur without performing the UL reception or the DL transmission.

For example, in the sub-band #1 since when the DL transmission addressed to the UE3 in adjacent sub-bands #2 and #3 is performed simultaneously with reception of the Ack signal or the Nack signal which is an example of the UL signal, the interference occurs. Therefore, it is inevitable to set a non-transmission interval in the sub-bands #2 and #3.

Therefore, the frequency use efficiency decreases and the accommodation efficiency of the UE3 also decreases. In addition, since the symbol length of the sub-band #2 is longer than the symbol length of the sub-band #3, the number of the non-transmission intervals tends to increase in the sub-band #2 and waste of resources tends to increase. Therefore, the merit of the sub-band #2 which is originally accommodate the UE3 with higher efficiency than the other sub-bands #1 and #3 is reduced.

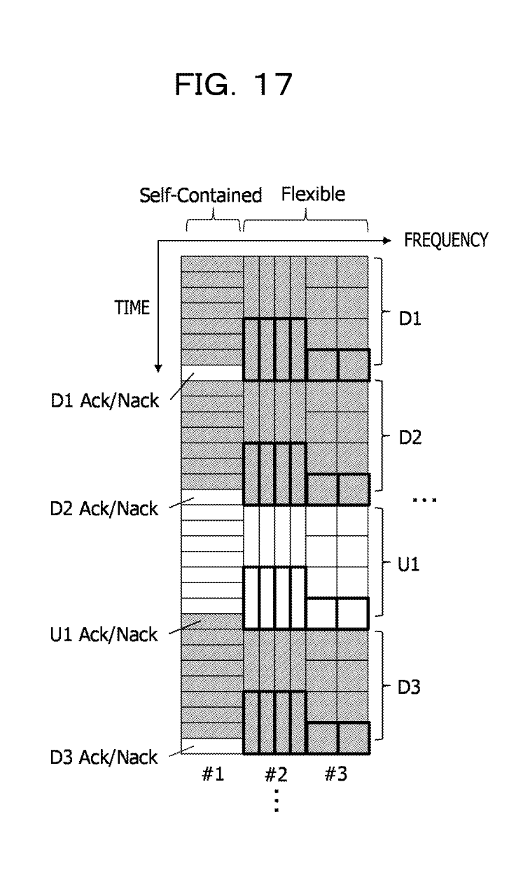

With respect to this, if the SIC process in the FD described above is used, since it is permitted that the UL reception and the DL transmission are simultaneously performed between the sub-bands as illustrated in FIG. 17, in the example of FIG. 16, it is possible to use a resource that is Null for communication with the UE3.

Accordingly, it is possible to avoid or suppress a decrease in the frequency use efficiency and to avoid or suppress a decrease in the accommodation efficiency of the UE3. In this case, since the resources of the UL and the DL do not overlap, the leakage power to the adjacent band becomes a major factor of the interference. Since the leakage power is about 1/10 or less of the signal power in many cases, the performance of the SIC may be about 1/10 of the SIC used in the common FD.

### Configuration Example of eNB2

Next, a configuration example of eNB2 will be described with reference to FIG. 18. As illustrated in FIG. 18, illustratively, the eNB2 may include DL data generating units 51-1 to 51-N, a multiplexing unit 52, a modulating unit 53, and a transmitting antenna 54 as an example of a transmission system.

N is an integer of 2 or more, and may illustratively correspond to the number of UEs 3 (UE #1 to UE #N) positioned in the wireless area 200 provided by the eNB2 and capable of communicating with the eNB2.

The transmission system may be regarded as an example of a transmitter that transmits the DL signals addressed to a plurality of UEs 3 in the DL band (for example, the system band) which is an example of the first frequency band.

In addition, as an example of the reception system, the eNB2 may include a receiving antenna 61, a demodulating unit 63, a separation unit 64, UL data decoding units 65-1 to 65-N, and a common channel data decoding unit 66.

The reception system may be regarded as an example of a receiver that receives the UL signals from a plurality of UEs 3 in the second frequency band (for example, the UL aggregation band) which is a part of the first frequency band.

Furthermore, the eNB 2 may include the scheduler 71 and a storage unit 72 as an example of a control system.

The DL data generating unit 51-j (j is any one of 1 to N) generates DL data to be transmitted to the UE #j. The resources used for transmitting the DL data addressed to the UE #j are allocated by scheduling for each UE #j by the scheduler 71.

The multiplexing unit 52 multiplexes the DL data addressed to UE #1 to UE #N generated by the DL data generating units 51-1 to 51-N.

The modulating unit 53 modulates the DL data multiplexed by the multiplexing unit 52 to generate a transmission modulated signal. For the modulation scheme, the OFDM may be applied, illustratively.

The transmitting antenna 54 transmits the transmission modulation signal obtained by the modulating unit 53 to the wireless area 200 provided by the eNB2. Although not illustrated in FIG. 18, the block including the transmitting antenna 54, the receiving antenna 61, and a SIC 62 may be configured as illustrated in FIG. 4 in more detail. Furthermore, a wireless unit for frequency-converting (up-converting) the transmission modulated signal into a wireless signal may be provided at the front stage of the transmitting antenna 54. The above-described HPA 101 may be provided in the wireless unit.

The receiving antenna 61 receives the wireless signal of the UL which is transmitted by the UE #j.

As described above, the SIC 62 suppresses the self-interference by canceling the DL transmission signal components from the received signal of the UL. The SIC 62 may implement the SIC process of the analog domain and the SIC process of the digital domain as described above.

The demodulating unit 63 demodulates the reception signal of the UL where the self-interference is suppressed by the SIC 62.

The separation unit 64 extracts and separates the UL signal for each UE #j from the signal demodulated by the demodulating unit 63 based on a scheduling information from the scheduler 71 and outputs the UL signal to the corresponding UL data decoding unit 65-j. In addition, the separation unit 64 extracts and separates the common channel signal of the UL from the signal demodulated by the demodulating unit 63, and outputs the common channel signal to the common channel data decoding unit 66 of UL.

The UL data decoding unit 65-j decodes the UL signal of the UE #j input from the separation unit 64 to obtain the reception data of the UL.

The common channel data decoding unit 66 of UL decodes the common channel signal of the UL input from the separation unit 64 to obtain common channel data.

The scheduler 71 schedules the resources used for the DL and UL communications for each UE #j. The scheduler 71 may be regarded as an example of a control unit for controlling the allocation of the DL band which is an example of the first frequency band and the second frequency band (for example, the UL aggregation band) which is a part of the DL band.

Illustratively, the storage unit 72 stores various types of programs, data, and information for realizing the operation and function of the eNB2. The data stored in the storage unit 72 may include system information including information relating to the system band, a scheduling result by the scheduler 71, an estimation result of the UL traffic volume by the scheduler 71 based on the SR or the BSR, and the like.

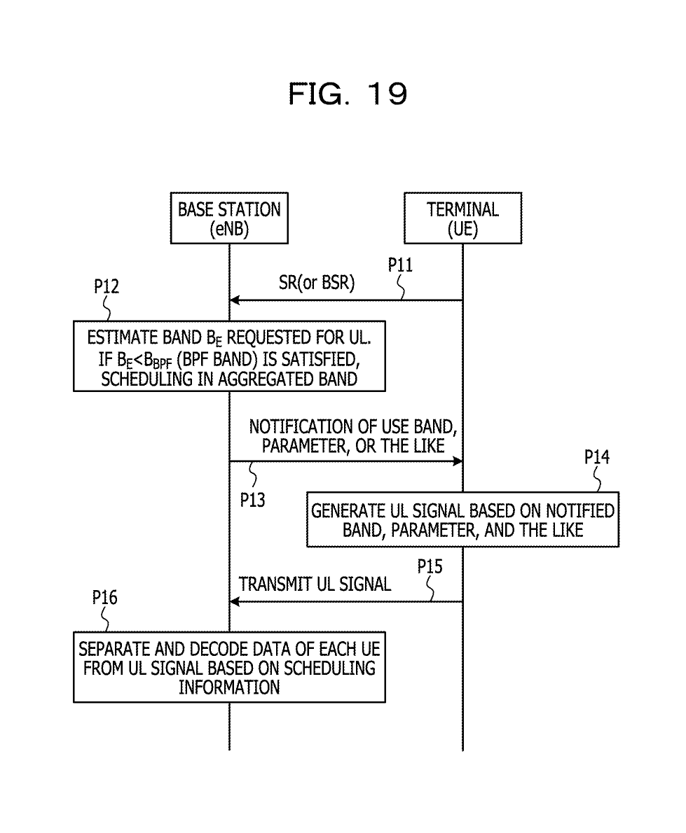

Hereinafter, an operation example focusing on the scheduling will be described with reference to FIG. 19. It is assumed that in each UE #j, the eNB2 and the DL are established.

The eNB2 receives the SR (it may be the BSR) transmitted by the UE #j according to the common channel of the UL or the channel of the UL which is already individually established with any of the UE #j (process P11).

The SR received from the UE #j is applied to the scheduler 71. Illustratively, the scheduler 71 estimates the amount of UL data to be transmitted by the UE #j of the SR transmission source based on the SR information, and estimates the frequency band (in other words, the subcarrier) corresponding to the UL data amount. The scheduler 71 estimates a frequency band B_{E} to be allocated to the UL transmission of each UE #j by adding the estimated frequency bands (process P12).

In a case where the total frequency bands BE are smaller than a pass bandwidth B_{BPF} of the BPF 206, the scheduler 71 performs scheduling such that the frequency resources within the passband (in other words, the UL aggregation band) of the BPF 206 are preferentially assigned to each UE #j.

The scheduling result (illustratively, the frequency resource to be used for the UL transmission by the UE #j) may be transmitted to UE #j with the signal parameters to be used in the UL signal by the UE #j as appropriate (process P13).

The UE #j generates the UL signal using the signal parameter notified from the eNB2 (it may be referred to as “designated”) (process P14), and performs the UL transmission using the frequency resource notified from the eNB2 (process P15).

The eNB2 separates and decodes the UL data for each UE #j from the reception UL signal based on the scheduling result of each user UE #j in the process P13 (process P16).

As described above, as illustrated in FIG. 5B or FIGS. 8 to 14 and 17, it is possible to preferentially allocate the frequency resources for the UL signal of each UE #j to the frequency band of a part of the DL band.

In the example of FIG. 19, since asymmetric traffic of the UL and the DL exists, simultaneous transmission of asymmetric bands of the UL and the DL occurs. On the other hand, the example of FIG. 17 is an example in which simultaneous transmission of asymmetric UL and DL occurs by selecting the frequencies corresponding to optimum parameters based on different environments of the UE3. The present embodiment can be applied to a system in which asymmetric simultaneous transmissions of the UL and the DL, and the SIC related to the asymmetric simultaneous transmission exist as described above.

For example, as illustrated in FIG. 5B, the scheduler 71 may allocate the frequency resource of the UL aggregation band to the reception of the UL signal even in a case where a reception quality of the UL signal is better than that of the DL band outside the UL aggregation band.

In addition, as illustrated in FIGS. 8 to 10, the scheduler 71 selects the BPF 206-i to be used according to the traffic volume of the UL signal (in other words, the signal amount), and the bandwidth of the UL aggregation band may be variably controlled. Here, as described above, the scheduler 71 may estimate the traffic volume of the UL signal based on the SR (or the BSR) received from the plurality of UEs 3.

Furthermore, as illustrated in FIG. 11, the scheduler 71 may allocate priority to transmission of DL signals from frequency resources which do not overlap with the UL aggregation band in the DL band.

Furthermore, as illustrated in FIG. 12, the scheduler 71 does not allocate the frequency resources overlapping the UL aggregation band in the DL band to the transmission of the DL signal.

Furthermore, as illustrated in FIG. 14, the scheduler 71 may set the UL aggregation band such that a part of the DL band deviates from the DL band on the side of the channel band disposed in the vicinity of the DL band.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A base station comprising:
a transmitter configured to transmit a downlink signal to a terminal device in a first frequency band;
a receiver configured to receive an uplink signal from the terminal device in a second frequency band narrower than the first frequency band, at least a part of the second frequency band being included in the first frequency band; and
a canceller circuit configured to execute a suppression process of a self-interference in which the downlink signal transmitted from the transmitter reaches the receiver and interferers with the uplink signal,
wherein the canceller circuit executes the suppression process by limiting to a third frequency band including the second frequency band and not including at least a part of the first frequency band.

2. The base station according to claim 1, wherein
the canceller circuit includes an analog canceller circuit that executes a first process of suppressing the self-interference in an analog domain of the uplink signal received by the receiver.

3. The base station according to claim 2, wherein
the canceller circuit includes a filter circuit that filters a frequency band of an output signal of the analog canceller circuit into the third frequency band.

4. The base station according to claim 3, wherein
the canceller circuit includes a conversion circuit that converts an output signal of the filter circuit into a digital signal.

5. The base station according to claim 4, wherein
the canceller circuit includes a digital canceller circuit that executes a second process for suppressing the self-interference in the digital domain to the digital signal outputted from the conversion circuit.

6. The base station according to claim 1 further comprising:
a scheduler configured to execute setting processes of the first frequency band and the second frequency band.

7. The base station according to claim 6, wherein
the scheduler is configured to allocate the second frequency band to the uplink signal, even when a first reception quality of the uplink signal in a case of using the second frequency band is better than a second reception quality of the uplink signal in a case of using the frequency band which is included in the first frequency band and is not included in the second frequency band.

8. The base station according to claim 6, wherein
the scheduler is configured to set the second frequency band based on a signal amount of the uplink signal.

9. The base station according to claim 7, wherein
the scheduler is configured to determine the signal amount of the uplink signal based on at least one of a signal requesting an allocation process received from the terminal device and a signal indicating a transmission data amount which is stored in the terminal device received from the terminal device.

10. The base station according to claim 6, wherein
the scheduler is configured to allocate a frequency band included in the first frequency band and not included in the second frequency band to the downlink signal prior to a frequency band included in the second frequency band.

11. The base station according to claim 6, wherein
the scheduler is configured to not allocate a frequency band included in the first frequency band and is included in the second frequency band to the downlink signal.

12. The base station according to claim 1, wherein
a first signal parameter of the downlink signal is different from a second signal parameter of the uplink signal, and
a first signal wave form of the downlink signal is different from a second signal wave form of the uplink signal.

13. The base station according to claim 6, wherein
the scheduler is configured to set the second frequency band such that a part of the second frequency band is disposed between the first frequency band and a channel frequency band adjacent to the first frequency band.

14. A method using a base station including a transmitter, a receiver and a canceller circuit, the method comprising:
transmitting, by the transmitter, a downlink signal to a terminal device in a first frequency band;
receiving, by the receiver, an uplink signal from the terminal device in a second frequency band narrower than the first frequency band, at least a part of the second frequency band being included in the first frequency band; and
executing, by the canceller circuit, a suppression process of a self-interference in which the downlink signal transmitted from the transmitter reaches the receiver and interferers with the uplink signal,
wherein the canceller circuit executes the suppression process by limiting to a third frequency band including the second frequency band and not including at least a part of the first frequency band.

15. The method according to claim 14, wherein the canceller circuit includes an analog canceller circuit, and the method further comprising:
executing, by the analog canceller circuit, a first process of suppressing the self-interference in an analog domain of the uplink signal received by the receiver.

16. The method according to claim 15, wherein the canceller circuit includes a filter circuit, and the method further comprising:
filtering, by the filter circuit, a frequency band of an output signal of the analog canceller circuit into the third frequency band.

17. The method according to claim 16, wherein the canceller circuit includes a conversion circuit, and the method further comprising:
converting, by the conversion circuit, an output signal of the filter circuit into a digital signal.

18. The method according to claim 17, wherein the canceller circuit includes a digital canceller circuit, and the method further comprising:
executing, by the digital canceller circuit, a second process for suppressing the self-interference in the digital domain to the digital signal outputted from the conversion circuit.

19. The method according to claim 14, wherein the canceller circuit includes a scheduler, and the method further comprising:
setting, by the scheduler, the first frequency band and the second frequency band.

20. The method according to claim 19, wherein
in the setting, the scheduler allocates the second frequency band to the uplink signal, even when a first reception quality of the uplink signal in a case of using the second frequency band is better than a second reception quality of the uplink signal in a case of using the frequency band which is included in the first frequency band and is not included in the second frequency band.
